(19) United States
(12) Patent Application Publication
(10) Pub. No.: US 2015/0278797 A1
(43) Pub. Date: Oct. 1, 2015

(54) Location and Proximity Based Authentication

(71) Applicant: BANK OF AMERICA CORPORATION, Charlotte, NC (US)

(72) Inventors: Todd E. Ratts, Littleton, CO (US); Russell B. Lewis, Charlotte, NC (US)

(73) Assignee: BANK OF AMERICA CORPORATION, Charlotte, NC (US)

(21) Appl. No.: 14/231,838

(22) Filed: Apr. 1, 2014

(51) Int. Cl. G06Q 20/32; G06Q 20/40

(52) U.S. Cl. CPC G06Q 20/3224; G06Q 20/3223; G06Q 20/40; G06Q 20/327

(57) ABSTRACT

According to certain embodiments, a system receives a request from a user to perform a banking function. The system stores rules for determining an authentication procedure. The system then determines a location of the user and determines an authentication procedure according to the requested banking function and the location of the user. The system applies the authentication procedure to the location of the user. The system determines whether the user is authenticated to perform the banking function according to the application of the authentication procedure.

### TECHNICAL FIELD

This invention relates generally to authentication and more particularly to location and proximity based authentication.

### BACKGROUND

Enterprises perform transactions on behalf of users and customers. Before performing a transaction, such as banking functions, enterprises perform due diligence to authenticate the customer. Currently, the information gathered to accomplish the due diligence is limited.

### SUMMARY OF EXAMPLE EMBODIMENTS

According to embodiments of the present disclosure, disadvantages and problems associated with location and proximity based authentication of a user may be reduced or eliminated.

In certain embodiments, a system receives a request from a user to perform a banking function. The system stores rules for determining an authentication procedure. The system then determines a location of the user and determines an authentication procedure according to the requested banking function and the location of the user. The system applies the authentication procedure to the location of the user. The system determines whether the user is authenticated to perform the banking function according to the application of the authentication procedure.

Certain embodiments of the present disclosure may provide one or more technical advantages. A technical advantage of one embodiment includes receiving location and proximity information of a user to mitigate the risk of fraud and improve authentication technologies. Another technical advantage of an embodiment includes the ability to specify criteria, to authenticate a user, such as location types or people accompanying a user. Yet another technical advantage of an embodiment includes creating centralized business rules for authenticating a user, which contributes to faster processing to quickly authenticate a user. Another technical advantage of an embodiment includes providing techniques to facilitate improving authentication for associated parties, such as an employer and employee, allowing an employer to automatically increase an employee's authentication by merely giving the employee a proximity beacon.

Certain embodiments of the present disclosure may include some, all, or none of the above advantages. One or more technical advantages may be readily apparent to those skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates a system according to certain embodiments that facilitates authentication of a user; and

FIG. 2 illustrates an example flowchart for facilitating authentication of a user.

### DETAILED DESCRIPTION

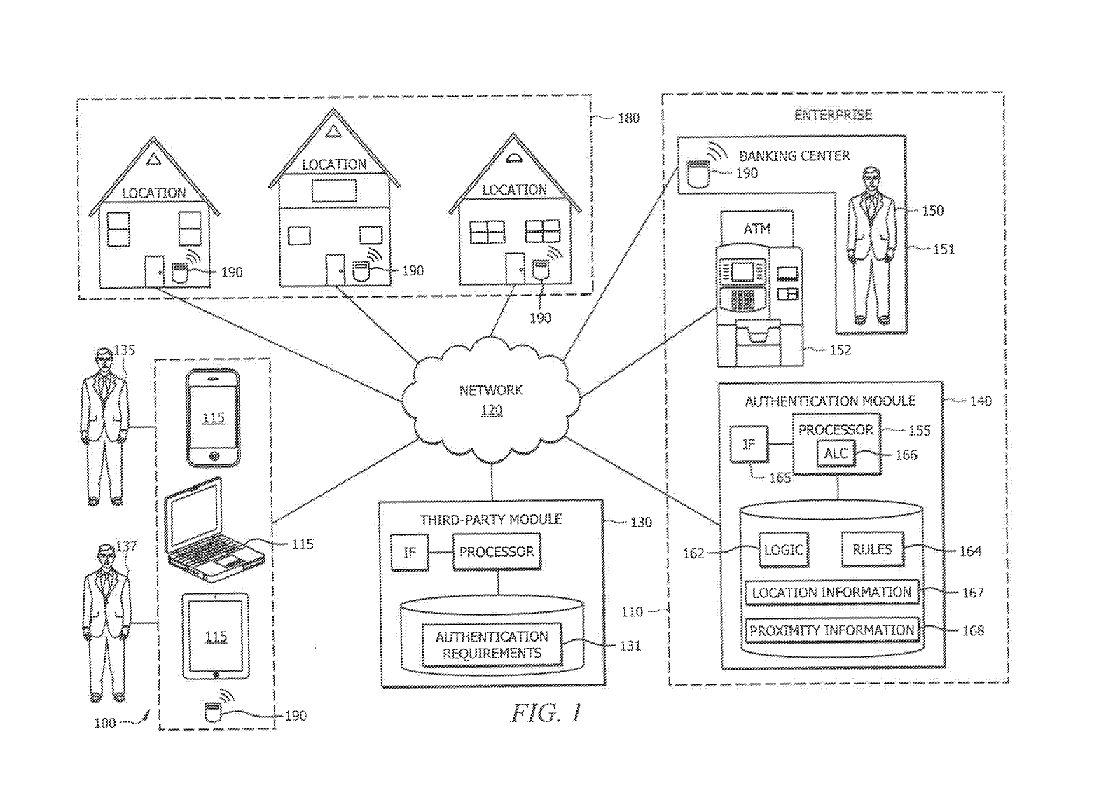

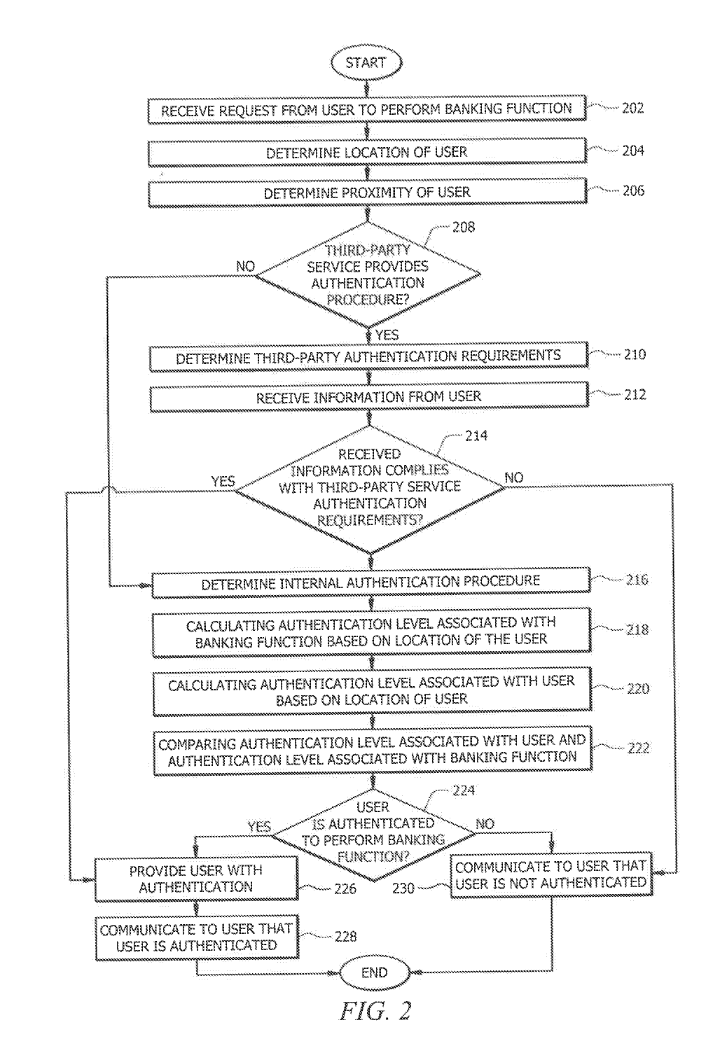

Embodiments of the present invention and its advantages are best understood by referring to FIGS. 1-2, like numerals being used for like and corresponding parts of the various drawings.

Banks, business enterprises, and other financial institutions that conduct transactions with customers may perform due diligence to authenticate a user. Examples of such transactions include, but are not limited to, opening an account, making a purchase, transferring money from an account, double signing a check, checking an account balance, and setting up an automatic bill pay. Typically, the information gathered to authenticate a user to perform a banking function may be limited to a general geographic location of a user. Normally, this limited geographical information does not provide a context in which a user is requesting to perform a banking function. The teachings of this disclosure recognize that it would be desirable to receive location and proximity information of a user to facilitate authenticating the user.

FIG. 1 illustrates a system 100 according to certain embodiments that facilitates authentication of a user. System 100 may include an enterprise 110, one or more user devices 115, one or more third-party modules 130, one or more authentication modules 140, one or more locations 180, one or more proximity beacons 190, one or more first users 135, and one or more second users 137. Enterprise 110, user devices 115, third-party modules 130, proximity beacons 190, and locations 180 may be communicatively coupled by a network 120. Enterprise 110 is generally operable to facilitate business transactions as described below.

In general, one or more authentication modules 140 may receive location and proximity information from first user 135 and determine whether first user 135 is authenticated to perform a requested banking function based on this received information. First user 135 may request to perform a banking function with enterprise 110. First user 135 may communicate a request to authentication module 140 utilizing user device 115. Using various location determining techniques, authentication module 140 determines the location of first user 135 and the proximity of first user 135 to second users 137, locations 180, proximity beacons 190, or banking centers 151. Based on location and proximity information and the requested banking function, authentication module 140 determines an authentication procedure and applies this authentication procedure. In some embodiments, having applied the authentication procedure, an authentication level is assigned to first user 135. In some embodiments, authentication module 140 calculates an authentication level associated with the banking function and calculates an authentication level associated with first user 135 based on the location of first user 135 and the proximity of first user 135 to various other locations. In some embodiments, authentication module 140 compares the two authentication levels and then determines whether first user 135 is authenticated to perform the requested banking function. Authentication module 140 may then communicate to first user 135 that first user 135 is authenticated to perform the banking function.

User device 115 may refer to any device that facilitates first user 135 conducting a transaction with enterprise 110. In some embodiments, user device 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. User device 115 may also comprise any suitable user interface such as a display, microphone, keyboard, or any other appropriate terminal equipment usable by first user 135. It will be understood that system 100 may comprise any number and combination of user devices 115. First user 135 utilizes user device 115 to interact with authentication module 140 to send a request to perform a banking function with enterprise 110 and to receive authentication from the authentication module 140, as described below. One or more second users 137 also utilize user device 115 to interact with authentication module 140. Authentication module 140 gathers information from user device 115 to determine the location of one or more second users 137.

Network 120 may refer to any interconnecting system capable of transmitting audio, video, signals, data, messages, or any combination of the preceding. Network 120 may include all or a portion of a public switched telephone network (PSTN), public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

One or more locations 180 may refer to any entity or environment that is not associated with enterprise 110. For example, a location could be a home, retailer, merchant, business, public area, government building, or any other appropriate place. Authentication module 140 can determine the proximity of first user 135 to one or more locations 180.

One or more third-party modules 130 may refer to any module that is not associated with and is remote to enterprise 110. Third-party modules 130 are typically associated with a third-party service that provides a service to first user 135. For example, a third-party service represents a web service that accepts payments, a separate banking enterprise transferring funds to an account of user 135, or a credit card company that is setting up an automatic bill pay for user 135. In some embodiments, third-party modules 130 may include a processor, memory, and an interface. Memory contains third-party service authentication requirements 131. Authentication module 140 is capable of receiving these third-party service authentication requirements 131 for determining whether first user 135 is authenticated to perform a banking function.

One or more proximity beacons 190 may refer to any object that user device 115 can detect wirelessly. Proximity beacons 190 may come in any suitable format, including radio-frequency identification (RFID) chips, small coin cell powered devices, and USB sticks. Examples of proximity beacons 190 include iBeacon, Gimbal Proximity Beacons, and Estimote Bluetooth® Smart Beacon. Proximity beacons 190 are generally operable to be detected by user device 115 and provide further authentication to first user 135. For example, an employee may be allowed to use a company credit card only for buying office supplies. However, when user device 115 detects that the employee is within a certain distance from proximity beacon 190, or is carrying proximity beacon 190, then the employee may receive a higher authentication level that allows the employee to make other purchases, such as buying meals at a restaurant. As another example, proximity beacon 190 may be located indoors, such as a store at a mall, and may provide more specific location information for first user 135. For example, in scenarios when a Global Positioning System (GPS) only detects that first user 135 is inside of a mall, proximity beacon 190 may detect that first user 135 is inside a particular store in the mall, or even a particular section of the store.

Enterprise 110 may refer to a financial institution, such as a bank, and may include one or more servers 140, one or more banking centers 151, one or more banking associate 150, and one or more ATMs 152.

Authentication module 140 may refer to any suitable combination of hardware and/or software implemented in one or more modules to process data and provide the described functions and operations. In some embodiments, the functions and operations described herein may be performed by a pool of authentication modules 140. In some embodiments, authentication module 140 may include, for example, a mainframe, server, host computer, workstation, web server, file server, a personal computer such as a laptop, or any other suitable device operable to process data. In some embodiments, authentication module 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, authentication module 140 receives a request from first user 135 utilizing user device 115 to perform a banking function, receives location information 167 and proximity information 168 associated with first user 135 and one or more locations 180, proximity beacons 190, second users 137, and banking centers 151. authentication module 140 determines whether first user 135 is authenticated to perform the requested banking function. In some embodiments, Authentication modules 140 may include a processor 155, memory 160, and an interface 165.

Memory 160 may refer to any suitable device capable of storing and facilitating retrieval of data and/or instructions. Examples of memory 160 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Although FIG. 1 illustrates memory 160 as internal to authentication module 140, it should be understood that memory 160 may be internal or external to authentication module 140, depending on particular implementations. Also, memory 160 may be separate from or integral to other memory devices to achieve any suitable arrangement of memory devices for use in system 100.

Memory 160 is generally operable to store logic 162, rules 164, location information 167, and proximity information 168. Logic 162 generally refers to algorithms, code, tables, and/or other suitable instructions for performing the described functions and operations. Rules 164 generally refer to policies or directions for determining and applying an authentication procedure to determine whether first user 135 is authenticated to perform the requested banking function. Rules 164 may be predetermined or predefined, but may also be updated or amended based on the needs of enterprise 110. Location information 167 and proximity information 168 generally refer to information associated with first user 135 and one or more locations 180, proximity beacons 190, second users 137, and banking centers 151.

Memory 160 communicatively couples to processor 155. Processor 155 is generally operable to execute logic 162 stored in memory 160 to determine whether first user 135 is authenticated to perform the banking function according to the disclosure. Processor 155 also contains authentication level calculator (ALC) 166, ALC 166 generally refers to any suitable device operable to calculate authentication levels to facilitate determining whether first user 135 is authenticated to perform the requested banking function. Processor 155 may comprise any suitable combination of hardware and/or software implemented in one or more modules to execute instructions and manipulate data to perform the described functions for authentication module 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for authentication module 140, send output from authentication module 140, perform suitable processing of the input or output or both, communicate to other devices, or any combination of the preceding. Communication interface 165 may include appropriate hardware (e.g., modem, network interface card, etc,) and/or software, including protocol conversion and data processing capabilities, to communicate through network 120 or other communication system that allows authentication module 140 to communicate to other devices. Communication interface 165 may include any suitable software operable to access data from various devices such as user devices 115, locations 180, and third-party modules 130. Communication interface 165 may also include any suitable software operable to transmit data to various devices such as user devices 115. Communication interface 165 may include one or more ports, conversion software, or both. In general, communication interface 165 may receive a request from user device 115, information from locations 180, and information from third-party modules 130.

In operation, logic 162 and rules 164, upon execution by processor 155, facilitate receiving location information 167 and proximity information 168 as well as determining whether first user 135 is authenticated to perform the requested banking function. Logic 162 and rules 164 also facilitate calculating authentication levels as determined by ALC 166.

In some embodiments, authentication module 140 determines the location of first user 135 through user device 115 and stores location information 167. Authentication module 140 may also determine the location of other entities, such as locations 180 or banking center 151 and may store this location information 167. Location may be determined by any acceptable means, such as through a GPS, cellular triangulation, Wi-Fi based positioning system (WPS), or a mapping function. Location may be determined on a constant basis or only after a request to perform a banking function is received. Authentication module 140 may also determine proximity information 168. In certain embodiments, authentication module 140 may determine this proximity information 168 by directly receiving proximity information or by comparing the location of first user 135 to other locations 180.

In some embodiments, authentication module 140 determines an authentication procedure according to the requested banking function and the location of first user 135, in certain embodiments, authentication procedures may be specifically associated with the requested banking function. For example, if first user 135 requests the banking function of double signing a check, then the correlated authentication procedure may include determining the proximity of first user 135 to a second user 137, such as the spouse of first user 135. In certain embodiments, authentication procedures may not be specifically related to the requested banking function. Instead, authentication module 140 would determine an authentication procedure according to the requested banking function and the location of first user 135. For example, authentication module 140 collects location information 167 and proximity information 168 and determines, based on the total context, what authentication procedure to use.

In some embodiments, authentication module 140 determines whether a third-party service provides an authentication procedure. Through interface 165, authentication module 140 may receive third-party authentication requirements 131 and use this information to apply the authentication procedure. An example of a third-party service may be a web service accepting payments for a store's raffle. In order to enter the raffle, the web service may provide certain authentication requirements before accepting payment, such as requiring that first user 135 be present in the store to buy a raffle ticket. Authentication module 140 may receive third-party service authentication requirements 131, receive location information 137 and proximity information 138 from first user 135, and then determine whether location information 137 and proximity information 138 complies with authentication requirements 131 provided by the web service. In this way, the third-party service dictates the authentication procedure based on the authentication requirements.

In some embodiments, authentication module 140 calculates authentication levels to determine whether first user 135 is authenticated to perform the requested banking function. In some embodiments, an authentication level may include categories such as regular inquiry, step-up inquiry, regular maintenance, step-up maintenance, high risk maintenance, regular payment/transfer/bill pay, step up payment/transfer/bill pay, and high risk payment/transfer/bill pay. It will be understood that authentication levels may comprise any number of various categories and are not restricted to those mentioned here. For example, if user 135 requests that enterprise 110 transfer $50, the authentication level for that activity may be regular transfer; however, if user 135 requests that enterprise 110 transfer $50,000, the authentication level for that activity may be step-up transfer or high risk transfer.

In some embodiments, ALC 166 represents any suitable device operable to calculate authentication levels. In certain embodiments, ALC 166 calculates two types of authentication levels: (1) an authentication level associated with the banking function and based on the location of first user 135 and (2) an authentication level associated with first user 135 and based on the location of first user 135. ALC 166 calculates an authentication level associated with the banking function and based on the location of first user 135 using rules 164 and logic 162. For example, if first user 135 wants to buy $10 worth of food at a restaurant, ALC would calculate an authentication level for that transaction. In some embodiments, the greater the number of restrictions before performing a banking function, the higher the authentication level associated with the banking function.

In some embodiments, ALC 166 may also calculate an authentication level associated with first user 135 based on the location of first user 135 using rules 164, logic 162, location information 167, and proximity information 168. An authentication level associated with user 135 represents the level of banking functions user 135 is authenticated to perform. For example, ALC 166 may determine user 135 has an authentication level of only regular payment, which means user 135 is authenticated to perform any banking function that also has an authentication level of regular payment. In some embodiments, an authentication level associated with first user 135 may be raised if user 135 has location information 167 and proximity information 168 that complies with rules 164. For example, if first user 135 wants to buy $10 worth of food at a restaurant, the authentication level of first user 135 may be raised if proximity information 167 shows that second user 137, for example a parent of first user 135, is with first user 135. The authentication level associated with first user 135 may also be lowered if proximity information shows that the restaurant is in a mall, and first user 135 is not authorized to purchase food in the mall. The factors that influence the authentication level may be updated depending on the preferences of the enterprise. In certain embodiments, authentication module 140 may compare the authentication level associated with first user 135 and the authentication level associated with the banking function to determine whether first user 135 is authenticated to perform the banking function based on the comparison.

It will be understood that ALC 166 may determine any number of separate authentication levels. Although FIG. 1 illustrates ALC 166 as internal to authentication module 140, it should be understood that ALC 166 may be internal or external to authentication module 140, depending on particular implementations.

In an exemplary embodiment of operation, first user 135 utilizes user device 115 to send a request to conduct a banking function over network 120 to enterprise 110. Authentication Module 140 receives the request and determines location information 167 and proximity information 168 from first user 135, one or more second users 137, one or more locations 180, one or more proximity beacons 190, and one or more banking centers 151. Authentication module 140 then uses logic 162 and rules 164, and ALC 166 to calculate authentication levels for the banking function and first user 135 based on location information 167 and proximity information 168. Authentication module 140 compares the authentication levels to determine whether first user 135 is authenticated to perform the banking function. Authentication module 140 then communicates to first user 135 whether first user 135 is authenticated to perform the requested banking function.

A component of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to the systems described herein without departing from the scope of the invention. For example, system 100 may include any number of first users 135, user devices 115, networks 120, third-party modules 130, locations 180, and enterprises 110. Moreover, the operations may be performed by more, fewer, or other components. Additionally, the operations may be performed using any suitable logic comprising software, hardware, and/or other logic. As used in this document, “each” refers to each member of a set or each member of a subset of a set.

FIG. 2 illustrates an example flowchart for facilitating authentication of a user. The method begins at step 202 by receiving a request from first user 135 to perform a banking function. In some embodiments, the request may be initiated by first user 135 through an enterprise application on user device 115. In some embodiments, the request may be initiated by first user 135 utilizing a bank card, such as a debit card or credit card, when making a purchase. Examples of banking functions include opening an account, making a purchase, transferring money from an account, double signing a check, checking an account balance, and setting up an automatic bill pay.

At step 204, authentication module 140 determines the location of first user 135. For example, authentication module 140 may determine a country, state, or city first user 135 is in. As another example, authentication module 140 may determine a specific location such as a retailer, the home of first user 135, the home of a second user 137, or a specific longitude and latitude.

The proximity of first user 135 to various entities, other users, or locations may be determined at step 206. For example, the proximity of first user 135 to banking center 151 at step 206 may be determined. For example, authentication module 140 may determine whether first user 135 is within banking center 151, in a specific part of banking center 151, or within a certain distance of banking center 151. In certain embodiments, authentication module 140 also determines the proximity of first user 135 to banking associate 150. For example, if first user 135 wants to open a bank account, authentication module 140 can determine that first user 135 is inside banking center 151 and is in close proximity to the banking associate 150. In certain embodiments, this proximity information would increase the authentication level of first user 135.

Authentication module 140 may also determine the proximity of first user 135 to one or more second users 137. For example, authentication module 140 may determine whether first user 135 is in close proximity to a spouse, joint account owner, parent, coworker, boss, family member, or friend. In certain embodiments, this proximity information may raise or lower the authentication level of first user 135. For example, if first user 135 is with a parent or boss, the authentication level of first user 135 may be raised. As another example, if first user 135 is with a friend or coworker, the authentication level of first user 135 may be lowered.

Authentication module 140 may also determine the proximity of first user 135 to a pattern of location of first user 135. Authentication module 140 tracks first user 135's locations over a period of time to determine a pattern. First user 135 or banking associate 150 may also provide a location pattern of first user 135 to authentication module 140. For example, if first user 135 travels to work every Monday through Friday via the same route, and one morning stops at a coffee shop, authentication module 140 could determine the proximity of first user 135 to the location pattern, or work commute, of first user 135.

Authentication module 140 may also determine the proximity of first user 135 to one or more proximity beacons 190. For example, a boss can give an employee, first user 135, a proximity beacon 190 to carry with first user 135 when first user 135 needs to make special purchases for the company. As another example, proximity beacons 190 may be associated with a certain location 180, such as a store within a mall. In this example, proximity beacon 190 is an additional technique to determine how close first user 135 is to location 180.

Authentication Module 140 may also determine the proximity of first user 135 to one or more locations 180. For example, authentication module 140 may determine the proximity of first user 135 to the home of first user 135, a retailer location, an office, or another location.

At step 208, authentication module 140 then determines whether a third-party service provides an authentication procedure. If a third-party service does not provide an authentication procedure, authentication module 140 determines an internal authentication procedure in step 216. If a third-party service does provide an authentication procedure, authentication module 140 determines third-party authentication requirements 131 in step 210. In step 212, authentication module 140 then receives information from first user 135 according to third-party service authentication requirements. Once the information is received, in step 214 authentication module 140 determines whether the received information complies with the third-party service requirements. If the information complies with the third-party service requirements, the authentication module 140 provides the user with authentication in step 226. If the information does not comply with the third-party service requirements, in step 230, authentication module 140 communicates to first user 135 that first user 135 is not authenticated to perform the requested banking function and the method ends.

At step 216, authentication module 140 determines an authentication procedure according to the requested banking function and the location of first user 135. For example, a parent of first user 135 may give first user 135 $100 to spend on groceries. When first user 135 attempts to purchase items with the $100, then the authentication procedure may comprise determining the location of first user 135 and the proximity of first user 135 to a grocery store.

At step 218, authentication module 140 calculates an authentication level associated with the banking function and based on the location of first user 135. At step 220, authentication module 140 calculates an authentication level associated with first user 135 and based on the location of first user 135. This authentication level can be based on the location of first user 135, and also the proximity of first user 135 to banking center 151, banking 150, one or more second users 137, one or more locations 180, the location pattern of first user 135, one or more proximity beacons 190, and one or more locations 180. At step 222, authentication module 140 compares the authentication level associated with first user 135 and the authentication level associated with the banking function. Using the $100 for groceries example, authentication module 140 may determine the authentication level associated with the banking function requires a certain proximity of first user 135 to a grocery store. Authentication module 140 may determine the authentication level associated with first user 135 based on the proximity of first user 135 to the nearest grocery store. When comparing the authentication levels of the banking function and first user 135, authentication module 140 compares the required proximity of first user 135 to the actual proximity of first user 135 to determine if it is sufficient such that first user 135 is authenticated to complete the purchase.

At step 224, authentication module 140 determines whether first user 135 is authenticated to perform the requested banking function based on the comparison from step 222. If authentication module 140 determines first user 135 is not authenticated, then in step 230 authentication module 140 communicates to first user 135 that first user 135 is not authenticated to perform the requested banking function and the method ends. If authentication module 140 determines first user 135 is authenticated, then it provides first user 135 with authentication in step 226. In certain embodiments, the authentication to perform the banking function expires after a predetermined period of time. For example, the authentication may expire after one hour. If first user 135 attempts to perform the banking function after the expired time, then authentication module 140 would have to perform this method again for first user 135 to receive new authentication. In step 228, authentication module 140 communicates to first user 135 that first user 135 is authenticated to perform the requested banking function and the method ends. This communication may include the time frame for which the authentication is valid.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure. While discussed as authentication module 140 performing the steps, any suitable component of system 100 may perform one or more steps of the method. For example, user device 115 may receive information regarding the authentication levels, compare them, and determine whether first user 135 is authenticated to perform the requested banking function. User device 115 may then notify authentication module 140 that first user 135 is authenticated to perform the requested banking function.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for authentication of a user, comprising:
an interface operable to receive a request from a user to perform a banking function;
a memory operable to store rules for determining an authentication procedure; and
one or more processors communicatively coupled to the interface and operable to:
determine a location of the user;
determine the authentication procedure according to the requested banking function and the location of the user;
apply the authentication procedure to the location of the user; and
determine whether the user is authenticated to perform the banking function according to the application of the authentication procedure.

2. The system of claim 1, wherein the interface is further operable to communicate a response to the user that indicates whether the user is authenticated to perform the banking function.

3. The system of claim 1, wherein the one or more processors are operable to:
calculate an authentication level associated with the banking function based on the location of the user;
calculate an authentication level associated with the user based on the location of the user;
compare the authentication level associated with the user and the authentication level associated with the banking function; and
determine whether the user is authenticated to perform the banking function based on the comparison.

4. The system of claim 1, wherein the one or more processors are operable to:
determine whether a third-party service provides an authentication procedure;
determine authentication requirements associated with the third-party service;
receive information from the user according to the third-party service authentication requirements; and
determine whether the received information complies with the third-party service authentication requirements.

5. The system of claim 1, wherein the one or more processors are further operable to determine the proximity of the user to a selected one of a banking center, one or more second users, a pattern of location of the user, one or more proximity beacons, one or more locations, and any combination of a proceeding element.

6. The system of claim 1, wherein the authentication to perform the banking function expires after a predetermined period of time.

7. The system of claim 1, wherein the banking function is a selected one of opening an account, making a purchase, transferring money from an account, double signing a check, checking an account balance, and setting up an automatic bill pay.

8. A non-transitory computer-readable medium encoded with logic, the logic operable when executed to:
receive a request from a user to perform a banking function;
store rules for determining an authentication procedure;
determine a location of the user;
determine the authentication procedure according to the requested banking function and the location of the user;
apply the authentication procedure to the location of the user; and
determine whether the user is authenticated to perform the banking function according to the application of the authentication procedure.

9. The computer-readable medium of claim 8, wherein the logic is further operable to communicate a response to the user that indicates whether the user is authenticated to perform the banking function.

10. The computer-readable medium of claim 8, wherein the logic is further operable to:
calculate an authentication level associated with the banking function based on the location of the user;
calculate an authentication level associated with the user based on the location of the user;
compare the authentication level associated with the user and the authentication level associated with the banking function; and
determine whether the user is authenticated to perform the banking function based on the comparison.

11. The computer-readable medium of claim 8, wherein the logic is further operable to:
determine whether a third-party service provides an authentication procedure;
determine authentication requirements associated with the third-party service;
receive information from the user according to the third-party service authentication requirements; and
determine whether the received information complies with the third-party service authentication requirements.

12. The computer-readable medium of claim 8, wherein the logic is further operable to determine the proximity of the user to a selected one of a banking center, one or more second users, a pattern of location of the user, one or more proximity beacons, one or more locations, and any combination of a proceeding element.

13. The computer-readable medium of claim 8, wherein the authentication to perform the banking function expires after a predetermined period of time.

14. The computer-readable medium of claim 8, wherein the banking function is a selected one of opening an account, making a purchase, transferring money from an account, double signing a check, checking an account balance, and setting up an automatic bill pay.

15. A method for authentication of a user, comprising;
receiving a request from a user to perform a banking function;
storing, in a memory, rules for determining an authentication procedure;
determining, using a processor, a location of the user;
determining, using the processor, an authentication procedure according to the requested banking function and the location of the user;
applying, using the processor, the authentication procedure to the location of the user; and
determining, using a processor, whether the user is authenticated to perform the banking function according to the application of the authentication procedure.

16. The method of claim 15, further comprising communicating a response to the user that indicates whether the user is authenticated to perform the banking function.

17. The method of claim 15, wherein applying the authentication procedure comprises:
calculating an authentication level associated with the banking function based on the location of the user;
calculating an authentication level associated with the user based on the location of the user;
comparing, using the processor, the authentication level associated with the user and the authentication level associated with the banking function; and
determining whether the user is authenticated to perform the banking function based on the comparison.

18. The method of claim 15, wherein determining an authentication procedure comprises determining whether a third-party service provides an authentication procedure, and wherein applying the authentication procedure comprises:
determining authentication requirements associated with the third-party service;
receiving information from the user according to the third-party service authentication requirements; and
determining whether the received information complies with the third-party service authentication requirements.

19. The method of claim 15, wherein determining the location of the user further comprises determining the proximity of the user to a selected one of a banking center, one or more second users, a pattern of location of the user, one or more proximity beacons, one or more locations, and any combination of a proceeding element.

20. The method of claim 15, wherein the authentication to perform the banking function expires after a predetermined period of time.

21. The method of claim 15, wherein the banking function is a selected one of opening an account, making a purchase, transferring money from an account, double signing a check, checking an account balance, and setting up an automatic bill pay.
